(19) United States
(12) Patent Application Publication
(10) Pub. No.: US 2006/0104693 A1
(43) Pub. Date: May 18, 2006

(54) Braille-information processing apparatus, braille-information processing method, program, and storage medium

(75) Inventors: Makoto Takada, Shiojiri-shi (JP); Seiji Tanaka, Nogano-ken (JP)

Correspondence Address: HOGAN & HARTSON L.L.P., 500 S. GRAND AVENUE, SUITE 1900, LOS ANGELES, CA, 90071-2611, US

(73) Assignees: SEIKO EPSON CORPORATION; KING JIM CO., LTD

(21) Appl. No.: 11/244,683

(22) Filed: Oct. 5, 2005

(30) Foreign Application Priority Data
Nov. 16, 2004 (JP) 2004-332102

(51) Int. Cl. B41J 3/32

(52) U.S. Cl. 400/109.1

(57) ABSTRACT

There is provided a braille-information processing apparatus capable of performing, on a display screen, an edit display for editing braille information for braille embossing and a preview display for displaying an embossing image for the braille embossing. As the edit display, displayed is a cell mark including a non-embossing point mark indicative of a non-embossing point in each braille cell and an embossing point mark indicative of an embossing point, the embossing point mark being different in shape from the non-embossing point mark. As the preview display, displayed is an image of only the embossing point out of the non-embossing point and the embossing point.

### BACKGROUND OF THE INVENTION

1. Field of the Invention

The present invention relates to a braille-information processing method which processes braille information for braille embossing, a braille-information processing method, a program, and a storage medium.

2. Description of the Related Art

A known process sheet (braille label) is of a type on which braille recognizable by visually-impaired people and ink characters (representing normal printing characters as opposed to braille) recognizable by visually-normal people are arranged side by side (or overlapped with each other) in such a way that they are recognizable by both visually-impaired and visually-normal people. Furthermore, a known braille-information processing apparatus is of a type which performs ink-characters printing and braille embossing at the same time so as to form a process sheet on which braille and ink characters are arranged.

In using the apparatus of this type, however, the user has a difficulty to handle a braille image at an editing process actually before a braille embossing process, because he or she merely inputs/edits ink characters and converts the same into braille. Even if the user hits upon an idea of having a braille image displayed on a display screen, he or she will now face a problem on how it should be displayed to perform a convenient editing.

### BRIEF SUMMARY OF THE INVENTION

In view of the above deficiencies, it is an advantage of the present invention to provide: a braille-information processing apparatus which allows the user to easily and exactly handle editing results of a braille cell image and an embossing image prior to an embossing process, which in turn achieving an enhanced usability; a braille-information processing method; a program; and a storage medium.

According to one aspect of the present invention, there is provided a braille-information processing apparatus capable of performing, on a display screen, an edit display for editing braille information for braille embossing and a preview display for displaying an embossing image for the braille embossing. The apparatus comprises: edit display means for displaying, as the edit display, a cell mark including a non-embossing point mark indicative of a non-embossing point in each braille cell and an embossing point mark indicative of an embossing point in each braille cell, the embossing point mark being different in shape from the non-embossing point mark; and preview display means for displaying, as the preview display, a cell image of only the embossing point out of the non-embossing point and the embossing point.

According to another aspect of the present invention, there is provided a braille-information processing method capable of performing an edit display for editing braille information for braille embossing and a preview display for displaying an embossing image for the braille embossing. The method comprises: displaying, as the edit display, a cell mark including a non-embossing point mark indicative of a non-embossing point in each braille cell and an embossing point mark indicative of an embossing point; and displaying, as the preview display, an image of only the embossing point out of the non-embossing point and the embossing point.

According to these configurations, since a cell mark including a non-embossing point mark and an embossing point mark is displayed as an edit display, the embossing point and the non-embossing point are each defined, so that the user is allowed to easily and exactly handle editing results of a braille cell image to be edited. On the other hand, a preview display displays an image of only an embossing point to be reflected in an actual embossing result, thereby allowing the user to easily and exactly handle an embossing image prior to an embossing process.

Preferably, the braille-information processing apparatus further comprises point-specifying edit means capable of editing the cell mark by specifying either the embossing point or the non-embossing point.

According to this configuration, the user is allowed to easily edit braille information of a cell image represented by a cell mark by specifying an embossing point and an non-embossing point on a point-by-point basis. As a result, usability can be further enhanced.

Preferably, in the braille-information processing apparatus, the edit display means includes: cell mark display means for displaying the cell mark; and braille-transcription information display means for displaying braille-transcription information as information represented by a character corresponding to the cell mark.

According to this configuration, since braille-transcription information as information represented by a character corresponding to a cell mark is displayed together with the cell mark, the user is allowed to easily handle a braille cell image as well as the meaning thereof. As a result, usability can be further enhanced. Note that braille transcription herein refers to translation between information by a general character specification such as ink characters and information by a braille specification, and the braille transcription information refers to information represented by a character while complying with the braille specification such as writing with a space between words, and also serves as intermediary information.

Preferably, the braille-information processing apparatus further comprises braille-transcription edit means for forming or changing the cell mark by editing and converting the braille-transcription information.

According to this configuration, the user is allowed to easily edit braille information of a cell image by editing braille-transcription information. As a result, usability can be further enhanced.

Preferably, in the braille-information processing apparatus for displaying braille-transcription information, the edit display means further includes ink-characters information display means for displaying ink-characters information for ink-characters printing to be printed on a process sheet used in common with the braille embossing.

According to this configuration, the user is allowed to handle a braille cell image and the meaning (content) thereof as well as contents on the side of ink character because ink-characters information is displayed. Therefore, even when ink characters (printing) and braille (embossing) each represent different character information, the user is easily notified of the fact.

Preferably, the braille-information processing apparatus further comprises: ink-characters information edit means for editing the ink-characters information; and braille-transcription means for forming or changing the braille-transcription information by converting the ink-characters information.

According to this configuration, it is also possible to edit ink-characters information and reflect the same in braille-transcription information. Therefore, the user is allowed to indirectly edit braille information of a cell image by editing the ink-characters information. As a result, usability is can be further enhanced.

Preferably, in the braille-information processing apparatus for displaying ink-characters information, the edit display means displays the cell mark, the braille-transcription information, and the ink-characters information in such a way that they are arranged in parallel on a common display screen.

According to this configuration, the user is allowed to handle braille information of a cell image represented by a cell mark, the meaning thereof (braille-transcription information), and contents on the side of ink characters (ink-characters information) at the same time, and to easily see the relation between ink characters (printing) and braille (embossing).

Preferably, the braille-information processing apparatus for displaying the ink-characters information further comprises layout setting means for setting a layout of the process sheet on which the braille embossing and the ink-characters printing are performed, wherein the preview display means has a print image of the ink-characters printing displayed together with the embossing image in accordance with the set layout.

According to this configuration, since a print image of ink-characters printing is preview-displayed together with an embossing image in accordance with a set layout, the user is allowed to easily and exactly handle an image of process results for a sheet processing consisting of braille embossing and ink-characters printing relative to a common process sheet prior to printing and embossing processes. As a result, usability can be further enhanced.

According to still another aspect of the present invention, there is provided a program which performs the braille-information processing apparatus as defined in any one of the above or executes the braille-information processing method as defined in the above.

According to yet another aspect of the present invention, there is provided a storage medium which stores the program as defined in the above in such a way that it is readable by a device capable of processing the program.

According to these configurations, since it is possible to perform the braille-information processing apparatus as defined in any one of the above or execute the braille-information processing method as defined in the above, the user is allowed to easily and exactly handle editing results of a braille cell image and an embossing image prior to an embossing process by reading out such a program from the storage medium or the like and executing the same. As a result, usability can be further enhanced.

### BRIEF DESCRIPTION OF THE DRAWINGS

The above and other objects and the attendant features of the present invention will become readily apparent by reference to the following detailed description when considered in conjunction with the accompanying drawings wherein:

FIG. 1 is an external perspective view of a label forming apparatus according to an embodiment;

FIG. 2 is an external perspective view of the label forming apparatus of FIG. 1 with its cover open;

FIG. 3 is a schematic block diagram of the label forming apparatus of FIG. 1 as viewed from its control system;

FIGS. 4A and 4B are illustrations of a braille with six points and a cross section of an embossing convex portion;

FIGS. 5A and 5B are a plan view and a cross section of an embossing unit;

FIG. 6 is an illustration for explaining the feed of a tape in a braille embossing section;

FIG. 7 is a flow chart showing an entire process of the label forming apparatus;

FIGS. 8A to 8C are illustrations for supplementally explaining the process modes of FIG. 7;

FIGS. 9A to 9C are illustrations for supplememtally explaining a difference in the tape width of FIG. 7;

FIG. 10 is an illustration for operation when braille information is inputted and edited in accordance with a first example;

FIG. 11 is an illustration similar to and subsequent to FIG. 10;

FIG. 12 is an illustration similar to and subsequent to FIG. 10;

FIG. 13A to 13C are illustrations for showing some examples in which labels can be formed;

FIG. 14A to 14F are illustrations for showing some exemplified labels in which a layout setting is different from each other and examples of a preview display screens corresponding thereto;

FIG. 15 is an illustration similar to FIG. 10 in accordance with a second example;

FIG. 16 is an illustration similar to FIG. 10 in accordance with a third example;

FIG. 17 is an illustration similar to FIG. 10 in accordance with a fourth example;

FIG. 18 is an illustration for supplementally explaining a cell image display with SIX-POINT INPUT; and

FIGS. 19A to 19L are illustrations for showing various examples of a cell mark.

### DETAILED DESCRIPTION OF THE INVENTION

Hereinafter, a description will be made specifically about a label forming apparatus (braille-information processing apparatus) according to one embodiment of the present invention with reference to the accompanying drawings.

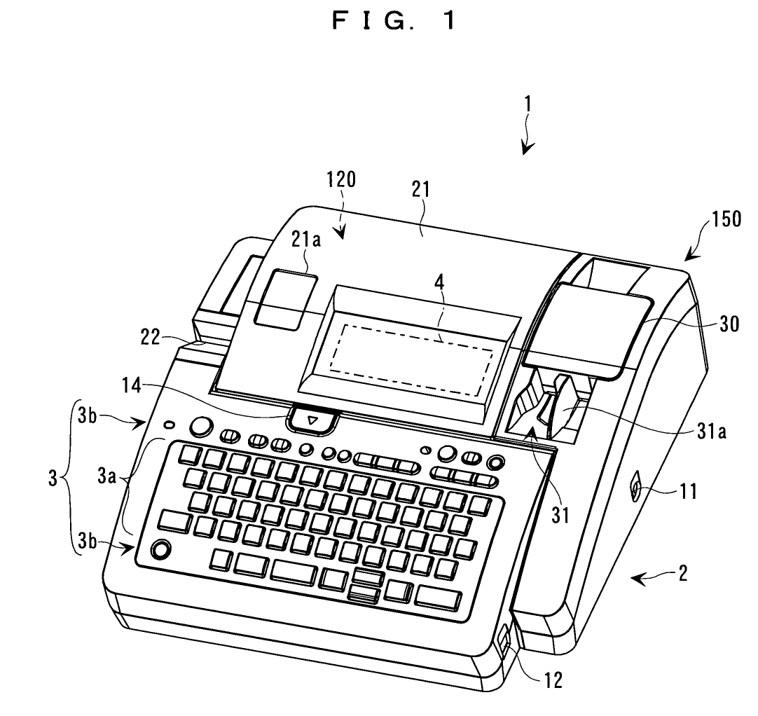

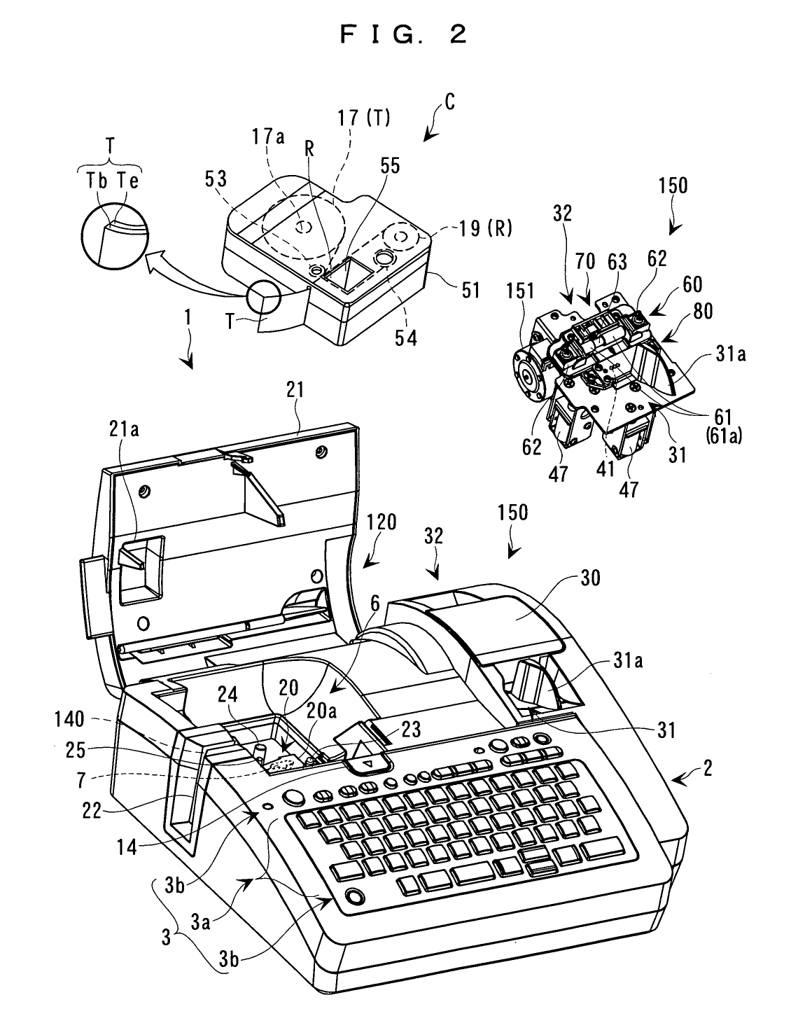

As shown in FIGS. 1 and 2, the label forming apparatus 1 has an outer shape formed by an apparatus casing 2. The apparatus casing 2 has a front top face where a keyboard 3 provided with various input keys is arranged, and a rear top face to which an opening/closing cover 21 is attached. The opening/closing cover 21 has a rectangular display 4 on the front side thereof.

Furthermore, inside the opening/closing cover 21, there is integrated an ink-characters printing section 120 for performing ink-characters printing (i.e., printing of characters such as letters and symbols) on a tape T reeled out from a tape cartridge C, and is provided a recessed cartridge mounting section 6 in which the tape cartridge C is mounted. The tape cartridge C is detachably mounted in the cartridge mounting section 6, with the opening/closing cover 21 being opened by depressing a cover opening button 14. In addition, the opening/closing cover 21 has an discrimination window 21a therein for discriminating the mounting/non-mounting of the tape cartridge C in its closed state.

Furthermore, on the right-hand neighbor of the opening/closing cover 21 (right upper half of the apparatus casing 2), there is integrated an assembly (braille embossing section 150 as shown in the right upper side of FIG. 2) for performing braille embossing. The assembly has an embossing section cover 30 attached to cover the same on the top face thereof. On the near side of the embossing section cover 30 is provided a recessed embossing-tape inserting port 31 into which the user manually inserts the tape (process sheet) T. On the back side of the embossing section cover 30 is provided a recessed embossing-tape ejecting port 32 from which the embossed tape T is ejected. Each of the near side and the back side is arranged in such a way as to have a decline along a tape traveling path (feeding passage) 70. In the vicinity of the embossing-tape inserting port 31, there is provided a manual insertion guide 31a which enables a tape width to be adjusted in a width direction thereof.

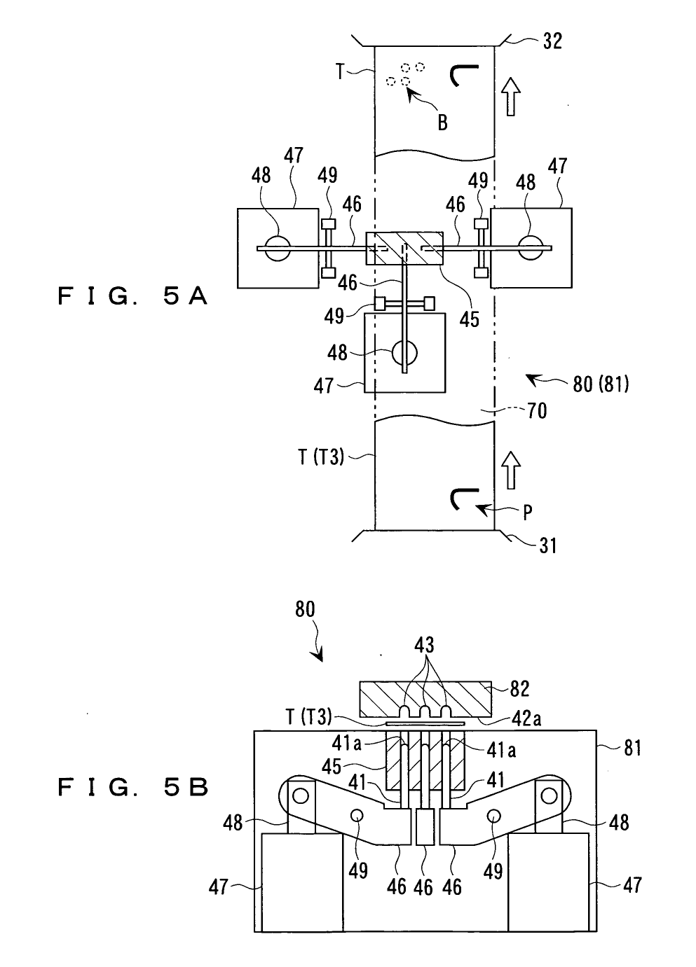

The braille embossing section 150 has an embossing unit 80 in which braille embossing is performed by three embossing pins (embossing heads) 41 (see FIG. 5B), a tape feeding unit (tape feeding mechanism) 60 which feeds the tape T inserted into the embossing-tape inserting port 31 to the embossing-tape ejecting port 32, and the tape traveling path 70 on which the tape T is transported. A frame constituting the tape traveling path 70 has the embossing unit 80 and the tape feeding unit 60 to arrange the embossing assembly, which is integrally mounted in the apparatus casing 2. The three embossing pins 41 are selectively driven by the embossing unit 80, so as to form braille B on the tape T which is fed along the tape traveling path 70 after the tape feeding unit 60 is driven.

At the center of the apparatus casing 2 on its right side, there is formed a power source supplying port 11 for power supply. At the front of the apparatus casing 2 on its right side, there is formed a connecting port (interface) 12 for connection with external devices (not shown) such as a personal computer. When the external devices are connected to the connecting port 12, it is made possible to print ink characters or emboss braille based on character information generated by the external devices. Furthermore, at the left side of the apparatus casing 2, there is formed a printing-tape ejecting port 22 for communicating the cartridge mounting section 6 with the outside. At the printing-tape ejecting port 22, a cutting section 140 is arranged to cut off the tape T fed out from the ink-characters printing section 120. The tape T printed with ink characters is ejected from the printing-tape ejecting port 22 with its rear end cut off by a cutting section 140.

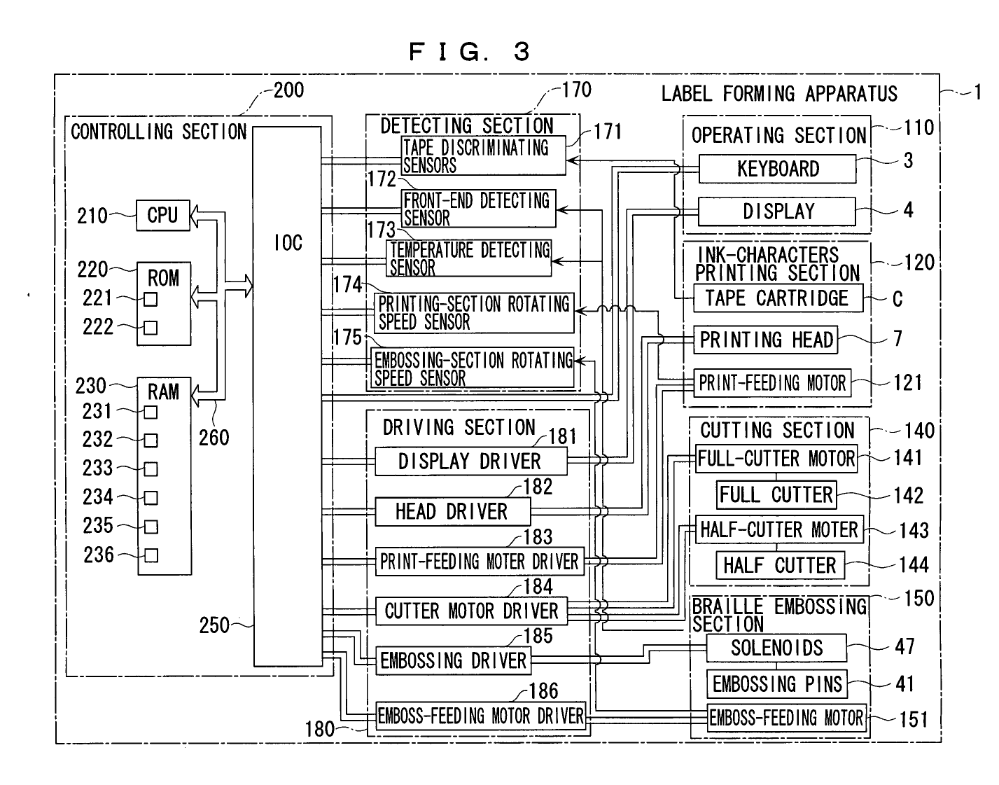

The label forming apparatus 1, as shown in FIG. 3, is composed of an operating section 110, an ink-characters printing section 120, and a cutting section 140 in its basic configuration. The operating section 110 has the keyboard 3 and the display 4, and serves as a man-machine interface which allows the user to input character information or display various information. The ink-characters printing section 120 has the tape cartridge C, a printing head 7, and a print-feeding motor 121, and prints on the tape T ink-characters while feeding the tape T and an ink ribbon R. The cutting section 140 has a full cutter 142, a half cutter 144, a full-cutter motor 141 and a half-cutter motor 143, which drive the full cutter and the half cutter, respectively, and cuts off the tape T printed with ink characters.

The label forming apparatus 1 is furthermore composed of a braille embossing section 150 and a detecting section 170. The braille embossing section 150 has solenoids 47, embossing pins 41, and an emboss-feeding motor 151, and embosses braille on the tape T while feeding the same. The detecting section 170 has: tape discriminating sensors 171 for detecting the type of the tape T (tape cartridge C); a transmission front-end detecting sensor 172 for detecting the front end of the tape T in the braille embossing section 150; a temperature detecting sensor 173 for detecting an ambient temperature (surrounding temperature) in the braille embossing section 150; a printing-section rotating speed sensor 174 for detecting the rotating speed of the print-feeding motor 121; and an embossing-section rotating speed sensor 175 for detecting the rotating speed of the emboss-feeding motor 151. With such sensors, the detecting section 170 performs various detections.

The label forming apparatus 1 is furthermore composed of a driving section 180 and a controlling section 200. The driving section 180 has a display driver 181, a head driver 182, a print-feeding motor driver 183, a cutter motor driver 184, an embossing driver 185, and an emboss-feeding motor driver 186. With such drivers, the driving section 180 drives each of the sections. The controlling section 200 is connected to each of the sections, and controls the label forming apparatus 1 as a whole.

The controlling section 200 has a CPU 210, a ROM 220, a RAM 230, and an input/output controller (hereinafter referred to as IOC) 250, all of which are connected to one another through an internal bus 260. The ROM 220 has a control program block 221 and a control data block 222. The control program block 221 stores control programs for controlling various processes including ink-characters printing or braille embossing with the CPU 210. The control data block 222 stores control data for controlling the embossing of braille data, etc., in addition to character font data for ink-characters printing and braille font data for braille embossing.

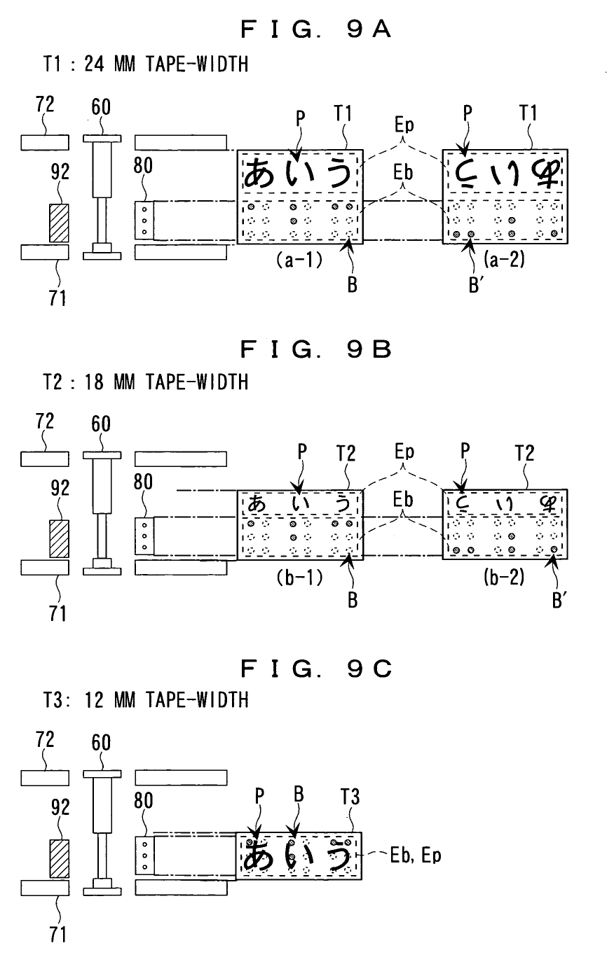

The RAM 230 has, in addition to various work area blocks 231 used as a flag, etc., an ink-characters data block 232 for storing generated ink-characters data; a braille data block 233 for storing generated braille data; a display data block 234 for storing display data to be displayed on the display 4; a layout block 235 for storing the layout of a set ink-characters printing region (printing arrangement area) Ep and a braille embossing region (embossing arrangement area) Eb; an inverted braille data block 236 for storing inverted braille data B′ (see FIGS. 9A to 9C) used in a case where braille data is embossed in an inverted state in accordance with the set layout. In other words, the RAM 230 is used as a work area for control processes. Further, the RAM 230 is always battery-protected for holding stored data in case of power-off.

The IOC 250 has a logic circuit incorporated therein for complementing functions of the CPU 210 and handles interface signals with various peripheral circuits through a gate array and a custom LSI. With this configuration, the IOC 250 receives into the internal bus 260 input data or control data through the keyboard 3 or various sensor values detected by the detecting section 170 either with or without processing the same. In addition, the IOC 250 outputs to the driving section 180 data or control signals outputted to the internal bus 260 from the CPU 210 either with or without processing the same while interlocking with the CPU 210.

With the above configuration, the CPU 210 inputs various signals/data from each section of the label forming apparatus 1 through the IOC 250 in accordance with the control programs of the ROM 220. Furthermore, the CPU 210 processes various data of the RAM 230 based on the inputted various signals/data, and outputs the various signals/data to each section of the label forming apparatus 1 through the IOC 250, thereby controlling the processes of ink-characters printing and braille embossing.

For example, when character information is inputted by the user through the keyboard 3, the CPU 210 generates ink-characters data P and braille data B based on the character information, and adjusts, as required, the length or the like between them to prepare inverted braille data B′ (see FIGS. 9A to 9C). Furthermore, the CPU 210 stores the ink-characters data (including margin data) P in the ink-characters data block 232 before or after having been subjected to the dimensional arrangement. In addition, the CPU 210 stores the braille data (including margin data) B in the braille data block 233 before or after it is subjected to the dimensional adjustment. Moreover, the CPU 210 stores the inverted braille data B′ in the inverted braille data block 236.

Upon receiving commands for ink-characters printing and braille embossing through the keyboard 3, the CPU 210 causes the print-feeding motor 121 to start and the printing head 7 to operate in response to a detection result by the printing-section rotating speed sensor 174, thereby performing ink-characters printing based on the ink-characters data P. Thereafter, the CPU 210 causes the tape to be fed at a given distance based on the ink-characters data after dimensional adjustment of the data as required. The tape T is then ejected from the printing-tape ejecting port 22 with its rear end cut off by the full cutter 142.

As shown in FIGS. 1 to 3, subsequently (in a state where no reset operation or power-off operation is made), when the user manually feeds the tape T cut into a strip into the embossing-tape inserting port 31, the CPU 210 drives the embossing unit 80 and the tape feeding unit 60, thereby performing braille embossing based on the braille data B or the inverted braille data B′. When the embossing is completed, the CPU 210 drives the emboss-feeding motor 151 to feed at a given distance the tape in which the braille data B, etc. has been arranged. The tape T is then ejected from the embossing-tape ejecting port 32.

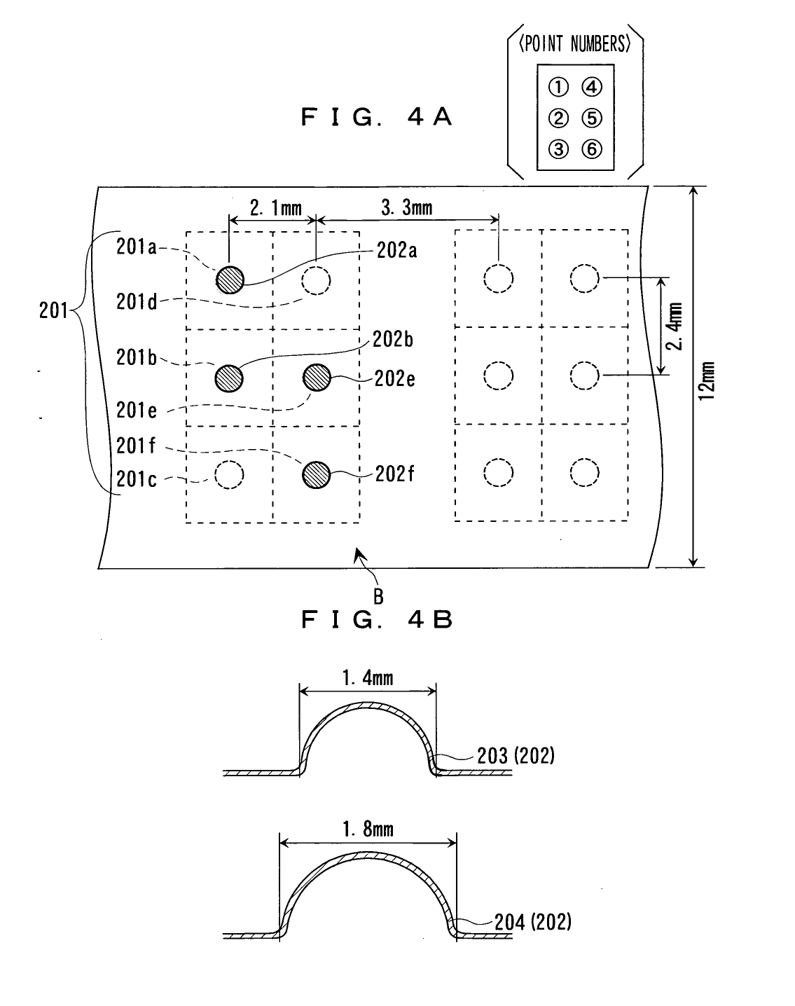

A description will now be made about braille B (six-point braille B), which is to be formed on the tape T, with reference to FIGS. 4A and 4B.

According to a specification (hereinafter referred to as a “de facto standard”) of a character (one cell) and a character spacing (between cells), which is used commonly with a brailler and a braille typewriter, as shown in the figures, the six-point braille B forms one cell 201 constituted of six points (embossing points: six points from the so-called “a first point” to “a sixth point” as shown in the upper right-hand of the figures), which in turn are constituted of three dots in length×two dots in width. The one cell 201 represents a character, a voice sound symbol, etc. with an arrangement pattern of embossing points and non-embossing points. FIG. 4A, for example, shows the braille (braille data) B representing character information “ [symbol] ” (hiragana character) where the first, second, fifth, and sixth points are embossing points and the third and fourth points non-embossing points.

Note that the braille B has, in addition to the six-point braille indicative of the above-described kana-character, numerals, etc., an eight-point braille (which forms one cell constituted of four dots in length×two dots in width) indicative of Chinese (kanji) characters. Although this embodiment refers to a six-point braille B, the present invention can also be applied to a label forming apparatus which forms an eight-point braille.

In the six-point braille B, the one cell 201 is divided into six embossing points from 201a to 201f with an arrangement pattern of three dots in length×two dots in width, with a vertical pitch between points being approx. 2.4 mm and a horizontal pitch approx. 2.1 mm, and a pitch between cells approx. 3.3 mm. FIG. 4A shows a state where four embossing points 201a, 201b, 201e, and 201f are selectively embossed from among the six embossing points 201a to 201f to represent the hiragana character “ [symbol] ,” and four embossing convex portions 202a, 202b, 202e, and 202f are formed on the tape T, each having a cross sectional shape with its corner rounded (see FIG. 4B) such as a cylinder, a hemisphere, a cone, and a quadrangular pyramid. Furthermore, to emboss the six-point braille B, the minimum required tape width is 12 mm long (tape T3) judging from the size (the length in the tape width direction) of the one cell 201.

Furthermore, the label forming apparatus 1 is provided with two other types of mutually replaceable units as the embossing unit 80: one forms small embossing convex portions 203, each having a diameter of approx. 1.4 mm, and the other large embossing convex portions 204, each having a diameter of approx. 1.8 mm. These two types of the embossing convex portions 203 and 204 may be used according to intended purpose. For example, the small embossing convex portions 203 are intended for those familiar with reading the braille B (congenital blind people), and the large embossing convex portions 204 for beginners (noncongenital blind people).

A description will be made specifically about FIGS. 1 to 3. The keyboard 3 has a characters key group 3a and a functions key group 3b for directing various operation modes, etc. arranged therein. The characters key group 3a is used for inputting character information for ink-characters printing and braille embossing, and is constructed in a full JIS-key arrangement. The functions key group 3b is, as in the case of a general word processor, etc., composed of: e.g., a conversion key for converting into Chinese (kanji) characters, etc.; a cancel key for canceling processes, etc.; a cursor key for moving a cursor; and a determination (enter) key for determining among alternatives on various selection screens or for starting a new line in inputting characters.

Furthermore, the functions key group 3b is composed of: a print executing key (printing key) for ink-characters printing and braille embossing; a feeding start key for directing the feed start of the tape T in the braille embossing section 150; an embossing start key for manual braille embossing; a mode key for selecting a process mode for ink-characters printing and braille embossing; a layout key for setting the arrangement of an ink-characters printing region (printing arrangement area) Ep and a braille embossing region (embossing arrangement area) Eb; a preview key for preview-displaying the arrangement results before the execution of printing; a scroll key for scroll-displaying the arrangement results; a braille input key for inputting and editing braille information; and a braille transcription key for generating a string of an intermediary character (string of braille transcription character) when a string of a normal character such as ink characters is converted into braille (braille transcription) or when a braille cell is read out.

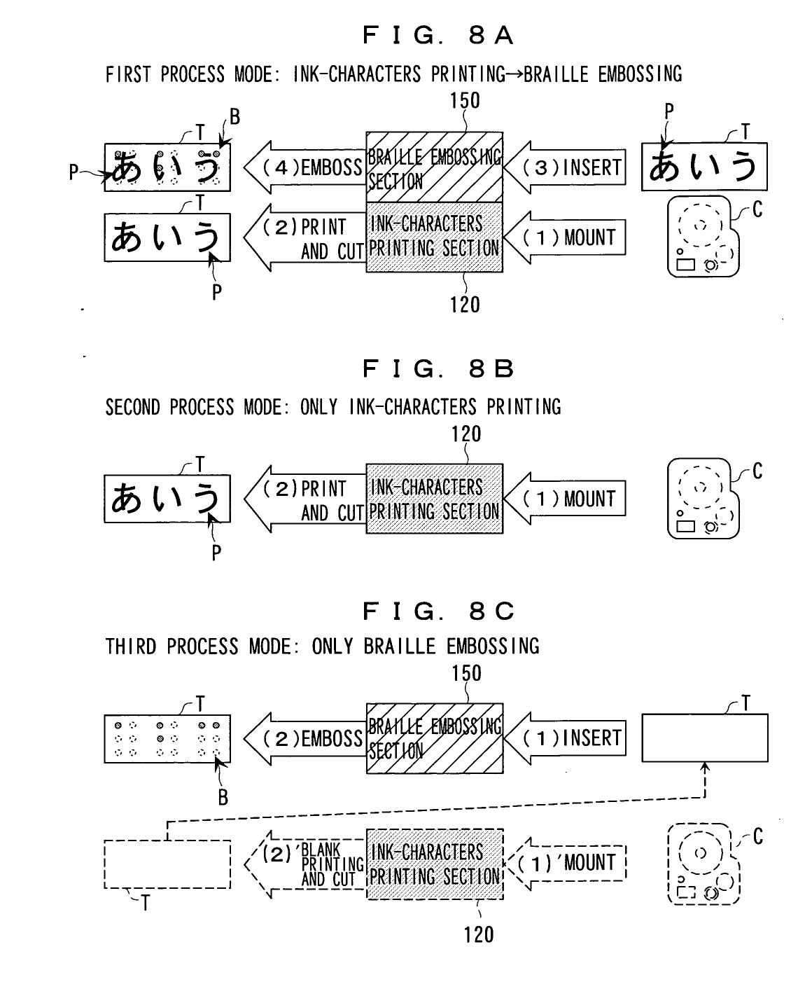

Process modes selected by the mode key include a first, a second, and a third process mode. In the first process mode, both ink-characters printing and braille embossing are performed based on inputted character information (see FIG. 8A). In the second process mode, only ink-characters printing is performed based on inputted character information (see FIG. 8B). In the third process mode, only braille embossing is performed based on inputted character information (FIG. 8C). One of the process modes is selected by the user.

The display 4 is rectangular with sides of approx. 12 cm in width (in X direction) and 5 cm in length (in Y direction) where a display image of 192 dots×80 dots can be displayed. It is used when the user inputs character information through the keyboard 3 to form and edit ink-characters data and braille data. It also displays various errors and messages (command contents) and notifies the user thereof.

In the ink-characters printing section 120, the cartridge mounting section 6 is provided with: a head unit 20 with a head cover 20a including a printing head 7 composed of a thermal head; a platen driving shaft 25 arranged at a position opposite to that of the printing head 7; a reel driving shaft 23 for reeling up an ink ribbon R; and a positioning projection 24 for a tape reel 17. In addition, a print-feeding motor 121 is embedded on the bottom of the cartridge mounting section 6 for rotating the platen driving shaft 25 and the reel driving shaft 23.

The tape cartridge C has a cartridge casing 51 in which the tape reel 17 and a ribbon reel 19 are accommodated. The tape T and the ink ribbon R have the same width in size. In the tape cartridge C, there is formed a through hole 55 to be fitted with the head cover 20a. Besides, at a position where the tape T and the ink ribbon R overlap each other, there is arranged a platen roller 53 which is driven to rotate by being fitted with the platen driving shaft 25. The ink ribbon R reeled out from the ribbon reel 19 is taken up by the ribbon taking-up reel 54 in such a manner as to travel around the head cover 20a.

When the tape cartridge C is mounted in the cartridge mounting section 6, the head cover 20a, the positioning projection 24, the platen driving shaft 25, and the reel driving shaft 23 are fitted with the through hole 55, the center hole 17a of the tape reel 17, the platen roller 53, and the center hole of the ribbon taking-up reel 54, respectively. The printing head 7 comes into contact with the platen roller 53 sandwiching the tape T and the ink ribbon R to perform ink-characters printing. Then, the tape T printed with ink characters is fed into the printing-tape ejecting port 22.

The tape T is composed of a substrate tape (substrate sheet: information forming layer) Tb whose rear face is provided with an adhesive layer and of a releasing tape (releasing sheet: releasing layer) Te affixed to the substrate Tb to cover the adhesive layer. The substrate tape Tb is composed of: in the order from the front side thereof, an image receiving layer with the enhanced fixation of ink thermally transferred from the ink ribbon R; a substrate layer made of a polyethylene terephthalate (PET) film, which serves as the main body of the substrate tape Tb; and the adhesive layer formed of an adhesive, in a stacked manner. The releasing tape Te is used to prevent dust etc. from adhering to the adhesive layer until the substrate tape Tb is used as a label, and is made of a quality paper (the one used in the embodiment is made of PET) whose front face is subjected to silicone treatment.

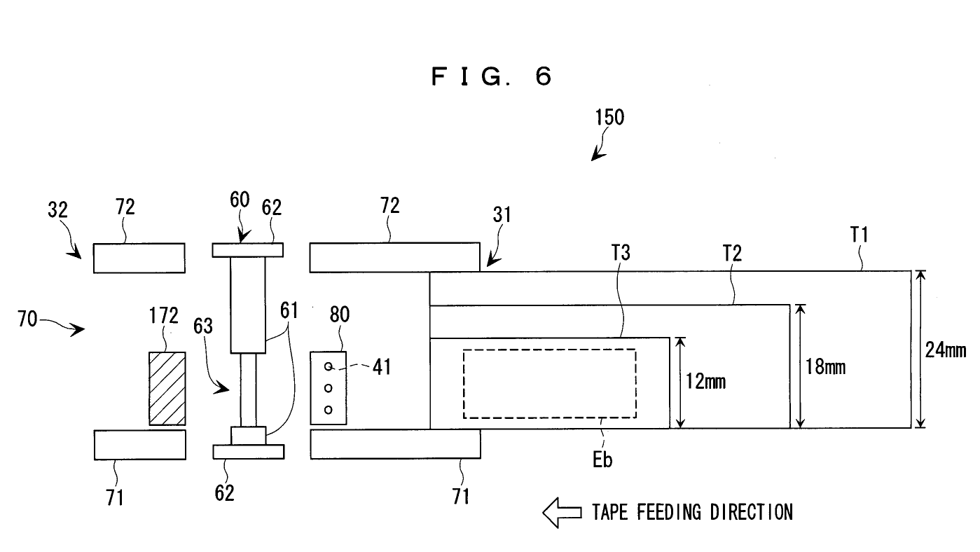

The tape T has a plurality of types varying in tape width, tape color, ink color of ink characters, tape material, etc. Therefore, there are provided a plurality of holes (not shown) for discriminating the types of the tape T on the rear face of the cartridge casing 51. In addition, in the cartridge mounting section 6, there are provided a plurality of tape discriminating sensors (micro switches) 171 for detecting the types corresponding to the plurality of holes. In other words, the tape type can be determined by detecting the state of the tape discriminating sensors 171. Note that a description of the present embodiment will be made about three types of tapes, that is, tape widths of 24 mm (tape T1), 18 mm (tape T2), and 12 mm (tape T3) (see FIG. 6).

Although not specifically shown in the figure, the full cutter 142 of the cutting section 140 is of a sliding type which has a cutting blade with an inclined cutting edge capable of slide-cutting in the vertical direction. The full cutter 142 has the cutting blade (cutter holder) operate slidably in the width direction of the tape T via a crank mechanism using the full-cutter motor 141 as a driving source. When the cutting blade operates slidably, both the substrate tape Tb and the releasing tape Te of the tape T facing the cutter blade is caused to be cut off, i.e., the tape T is full-cut.

Likewise, the half cutter 144 is of a sliding type which has a cutting blade with an inclined cutting edge and is substantially the same in shape as the full cutter 142. The half cutter 144 is arranged on the upstream side of tape feeding (on the side near the tape cartridge C), and is constructed in such a way as to operate slidably in the width direction of the tape T via a crank mechanism using the half-cutter motor 143 as a driving source. Unlike the full cutter 142, the amount of projection of the cutting blade in this case is adjusted to cut off only the substrate tape Tb. In other words, when the cutting blade operates slidably, only the substrate tape Tb of the tape T facing the cutter blade is caused to be cut off, i.e., the tape T is half-cut.

Next, in the braille embossing section 150, the embossing unit 80 is, as shown in FIG. 5B, composed of an embossing member (embossing head) 81 arranged on the rear face of the tape T and having the three embossing pins 41 and of an embossing receiving member 82 for receiving pushing (embossing) actions caused by the embossing pins 41 via the tape T at a position opposite to the embossing member 81. The embossing unit 80 is fixed in position at the lower end in the width direction of the tape traveling path 70.

The embossing member 81 is provided with the three embossing pins 41 arranged at intervals of 2.4 mm along the tape width direction (in the horizontal direction of the embossing unit in FIG. 5A). The three embossing pins 41 correspond to the vertically-arranged three embossing points 201a to 201c (or 201d to 201f) out of the six embossing points, and are held perpendicular to the tape T by guide members 45 which imparts a linear motion with solenoids 47 as a driving source. Head portions 41a of the embossing pins 41 are formed such that the embossing convex portions 202 are cross sectional shape with its corner rounded (see FIG. 4B) such as a cylinder, a hemisphere, a cone, and a quadrangular pyramid.

When the plungers 48 are linearly moved by the solenoids 47, the arm members 46 rotate about the supporting members 49, thereby causing the embossing pins 41 to move linearly in a direction perpendicular to the tape T. The three solenoids 47, each connected to the three arm members 46, are arranged in such a manner as to be positioned at each corner of a triangle. On the other hand, the embossing receiving member 82 has three embossing receiving concave portions 43 formed on a face 42a thereof opposite to the three embossing pins 41 for receiving the same. Thus, the embossing convex portions 202 are formed on the tape T by the embossing pins 41 and the embossing receiving member 82. Note that the face 42a opposite to the three embossing pins 41 may be of a flat one made of an elastic material such as a synthetic rubber, instead of having the embossing receiving concave portions 43 formed thereon.

As shown in FIG. 6, the tape feeding unit 60 is composed of: feeding rollers 61; supporting members 62 for supporting the feeding rollers 61 on an apparatus frame; and a reversible rotating emboss-feeding motor 151 (see FIG. 3) for rotating the feeding rollers 61. The feeding rollers 61 are composed of grip rollers having driving rollers (not shown) and driven rollers 61a. Between the driven rollers 61a are formed annular grooves 63 free from interference from vertical three positions (the positions corresponding to vertically-arranged three embossing points 201 (see FIG. 4A)) in the width direction of the tape traveling path 70, so as to prevent the formed braille B from being crushed.

In the embossing tape feeding port 31, the three types of tapes can be inserted in a decreasing order of tape width, i.e., tape T1 (with a width of 24 mm), tape T2 (with a width of 18 mm), and tape T3 (with a width of 12 mm). The tape T1 with the maximum tape width is guided by the upper and lower guide members 71 and 72, whereas the tapes T2 and T3, each with a smaller tape width than the tape T1, are guided only by the lower guide members 71. The user manually feeds the tape until the front end thereof reaches the tape feeding unit 60 (feeding rollers 61) (up to the furthest possible point of insertion). When the user depresses the feeding start key on the keyboard 3, the tape feeding unit 60 starts the feed of the tape T3.

Upon detection of the front end of the tape with the front-end detecting sensor 172, a braille embossing process starts (tape feeding and braille embossing based on inputted braille data are performed). At this time, when a length from the front end of the tape to an embossing start position is set shorter than a length ranging from the embossing pins 41 to the front-end detecting sensor 172, the feeding rollers 61 are caused to backlash to feed back the tape T. When the tape T is fed back to an adequate position by a counter rotation, embossing and feeding thereof to a normal direction start. Note that the user may manually start operating the embossing unit 80 by depressing the embossing start key on the keyboard 3, instead of allowing the front-end detecting sensor 172 to detect the front end of the tape.

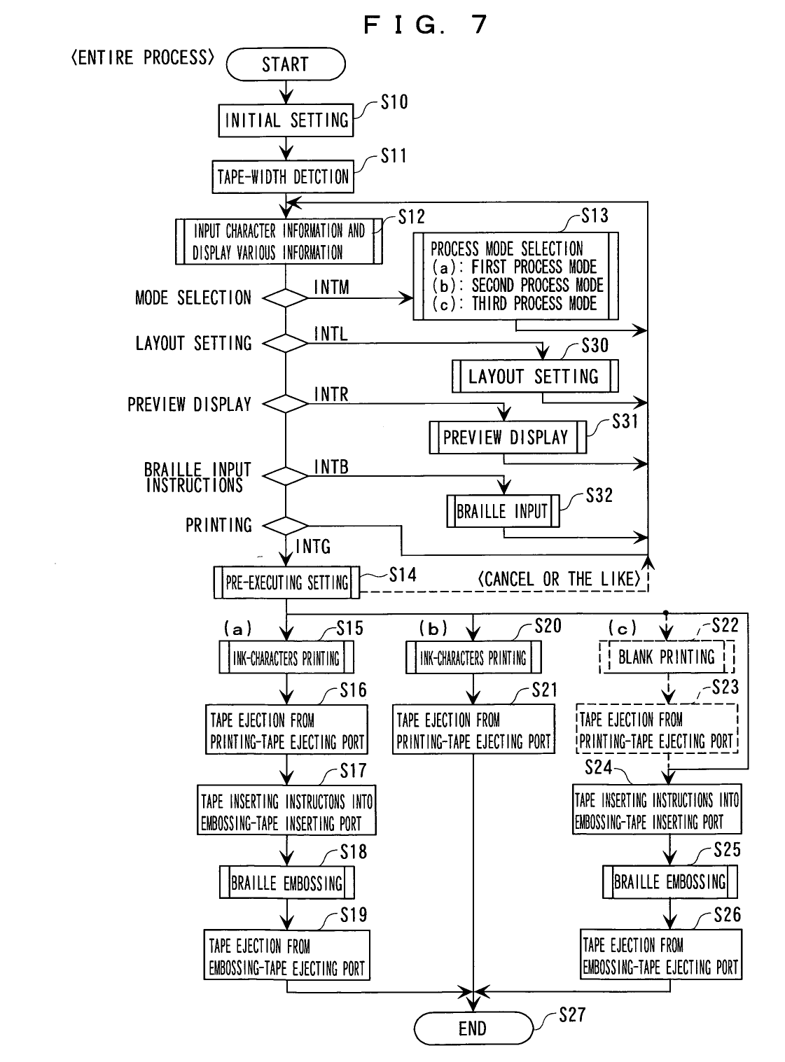

Next, a description will be made about the entire process of the label forming apparatus 1, with reference to FIGS. 7, 8A to 8C, and 9A to 9C. When the power key (power-on) is depressed, as shown in FIG. 7, to start a process, the respective saved control flags are restored to the initial setting so as to return to the previous power-off state (S10), and the tape discriminating sensors 171 (see FIG. 3) detect a type of tapes (S11). Subsequently, when the user inputs character information (in the form of data) through the keyboard 3 (or external devices such as a personal computer), various information are displayed on a text editing screen. (S12).

When a mode selecting interruption (INTM) results from mode selecting instructions (inputting of the mode key) through the keyboard 3 (or by input instructions through any external device), a process for a process mode selection start allowing the user to select one of a first process mode (ink characters and braille in combination), a second process mode (ink characters only), and a third process mode (braille only) (S13).

When a layout setting interruption (INTL) results from layout setting instructions (inputting of the layout key) (or by input instructions through any external device), a process for a layout setting starts (S30). When a preview display interruption (INTR) results from preview display instructions (inputting of the preview key) (or by input instructions through any external device), a process for a preview display starts (S31). When an interruption of braille input instructions (INTB) results from braille input instructions (inputting of the braille input key) (or by input instructions through any external device), a process for braille input starts (S32). When a print interruption (INTG) results from print executing instructions (inputting of the printing key) (or by input instructions through any external device), a process for a pre-executing setting starts (S14).

In the pre-executing setting (S14), settings including a layout arrangement, etc. and final confirmation of respective settings are made at times when actual ink-characters printing and braille embossing are performed. Note that, when the print interruption (INTG) occurs despite that there have occurred no mode selecting interruption, layout setting interruption, preview display interruption, or interruption of braille input instructions, the mode previously used is selected as default (FIRST PROCESS MODE, BRAILLE AT LOWER SIDE, INK CHARACTERS AND BRAILLE IN PARALELL, and INPUT INK CHARACTERS are selected as an initial setting). When the pre-executing setting (S14) is completed, the processes for actual ink-characters printing and braille embossing start.

In other words, in the first process mode (S13: (a)) as shown in FIGS. 7 and 8A, the label forming apparatus 1 causes the ink-characters printing section 120 to print on the tape T ink characters P (ink-characters printing) (S15) and cuts it off. Then, the tape T is ejected from the printing-tape ejecting port 22 (S16). On the display 4, tape inserting instructions into the embossing-tape inserting port 31 are displayed (S17). Note that these instructions may be displayed by an indicator or an LED.

When the user (manually) inserts the tape T into the embossing-tape inserting port 31 in response to the tape inserting instructions, the braille embossing section 150 embosses braille B thereon (braille embossing) (S18). Then, the tape T embossed in braille is ejected from the embossing-tape ejecting port 32 (S19), and the process is completed (S27).

Furthermore, in the second process mode (S13: (b)), the tape T is cut off and ejected (S21) after the ink-characters printing with the ink-characters printing section 120 (S20), and the process is completed (S27). In other words, in the second process mode, as shown in FIG. 8B, the tape T reeled out from the mounted tape cartridge C is fed into the ink-characters printing section 120 to print the ink characters P thereon.

Furthermore, in the third process mode (S13: (c)), tape inserting instructions into the embossing-tape inserting port 31 are displayed on the display 4 (S24). In response thereto, the tape T is inserted and embossed in braille (S25). Then, it is ejected from the embossing-tape ejecting port 32 (S26), and the process is completed (S27). In other words, a strip tape T (cut into a given length) is manually fed into the braille embossing section 150 and embossed in the braille B in the third process mode as shown in FIG. 8C.

Prior to the tape inserting instructions (S24), as given by dotted lines shown in FIGS. 7 and 8C, a blank printing (i.e., just feeding a tape) may be made in place of the ink-characters printing of the first process mode so as to make a strip tape T for manual insertion (S22). Then, the resulting tape T is cut off and ejected (S23). The ejected tape T may be used as a strip tape T for manual insertion. Although not shown in the figure, the label forming apparatus 1 may be arranged such that the tape cartridge C is mounted in an upstream of the braille embossing section 150, and an elongated tape reeled out from the tape cartridge C is embossed in braille. Furthermore, character information for use in ink-characters printing and braille embossing may be different from each other.

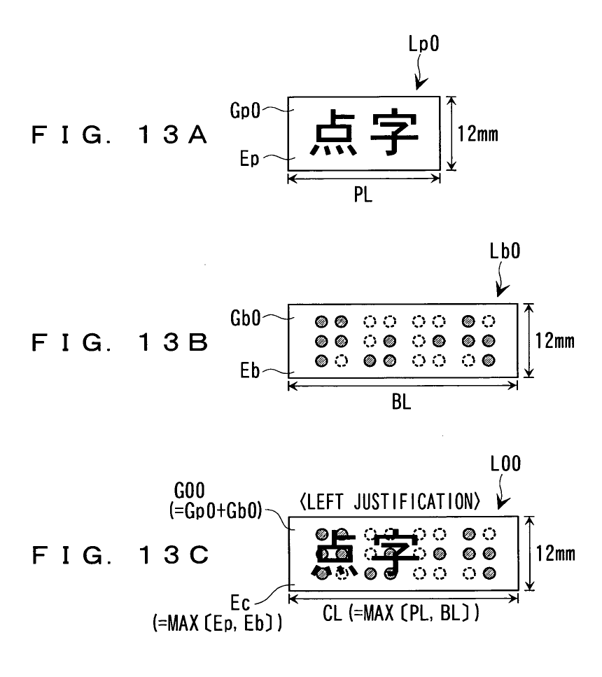

Next, in the layout setting (S30), the relative position between the ink-characters printing region (printing arrangement area) Ep and the braille embossing region (embossing arrangement area) Eb on the tape T (see FIGS. 9A to 9C, 13A to 13C, and 14A to 14F) and the length of the respective arrangement areas (a printing arrangement area length PL, an embossing arrangement area length BL, and a common arrangement area length CL) (see FIGS. 13A to 13E) are primarily set based on the results of the tape width detection (S11) and the process mode selection (S13). Besides, a character size for ink-characters printing, for example, is set in a manner similar to that used for general tape printing apparatuses and word processors.

Especially in the first process mode (ink characters and braille in combination), as shown in FIGS. 9A to 9C, when a tape width is detected to be 24 mm long (tape T1) (see FIG. 9A), the layout of the tape is selected from either the printing arrangement area Ep at the upper side and the braille arrangement area Eb at the lower side (a-1: hereinafter referred to as “BRAILLE AT LOWER SIDE”), or the printing arrangement area Ep at the lower side and the braille arrangement area Eb at the upper side (a-2: hereinafter referred to as “BRAILLE AT UPPER SIDE”).

Likewise, when a tape width is detected to be 18 mm long (tape T2) (see FIG. 9B), the layout of the tape is selected from either BRAILLE AT LOWER SIDE (b-1) or BRAILLE AT UPPER SIDE (b-2). In this case, however, the printing arrangement area Ep is shortened in the tape width direction in response to the tape width involved. In the cases of the tapes T1 and T2, a layout in which ink-characters, which is freely (e.g., widely) printed, and braille are overlapped with each other (hereinafter referred to as “INK CHARACTERS AND BRAILLE OVERLAPPED”) can be selected, in addition to the one on which ink characters and braille are arranged in parallel (hereinafter referred to as “INK CHARACTERS AND BRAILLE IN PARALLEL”).

When a tape width is detected to be 12 mm long (tape T3) (see FIG. 9C), which is the minimum length in which one cell 201 of the braille (length in the tape width direction) can be embossed (see FIG. 4A), the only acceptable layout is the one in which the printing arrangement area Ep and the embossing arrangement area Eb are overlapped with each other, irrespective of the arrangements of BRAILLE AT UPPER SIDE or BRAILLE AT LOWER SIDE and INK CHARACTERS AND BRAILLE IN PARALLEL or INK CHARACTERS AND BRAILLE OVERLAPPED, which may have already been selected.

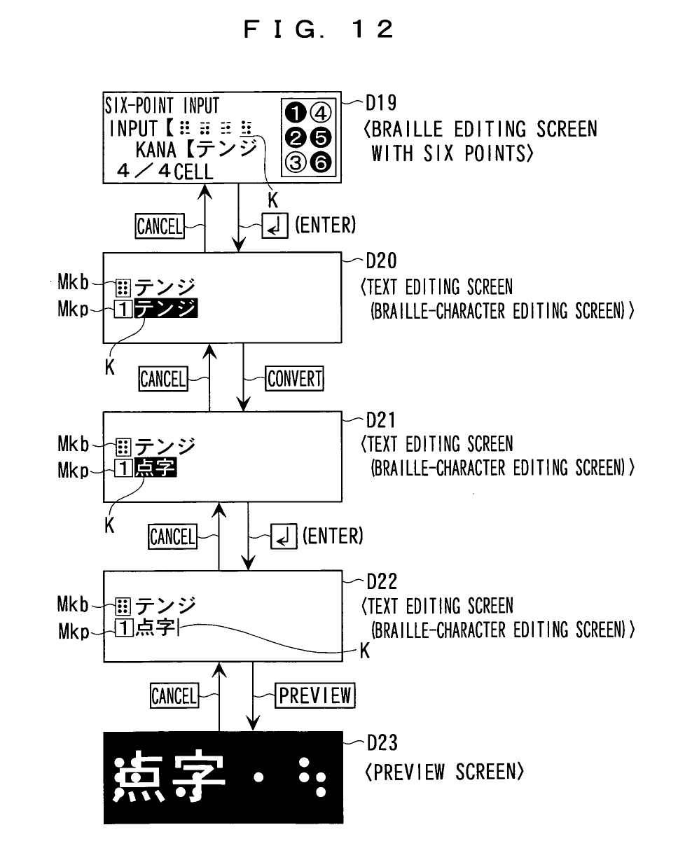

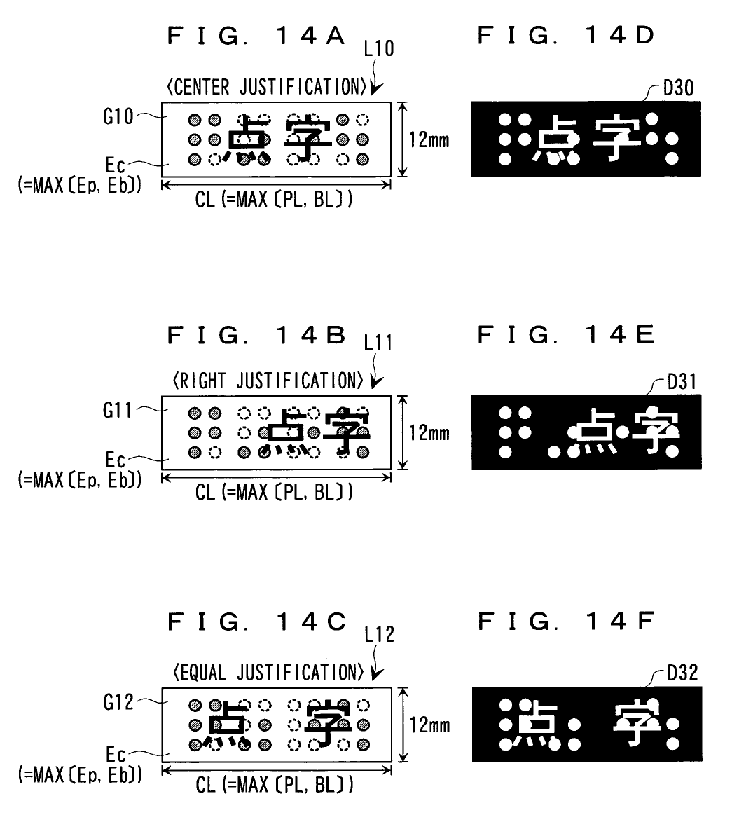

Next, the label forming apparatus 1 is capable of displaying on the display 4 a corresponding preview display screen (preview screen, monitor screen), in addition to a normal display screen such as a text editing screen. Therefore, according to the preview display (S31 of FIG. 7), displayed (previewed) on the monitor screen of the display 4 are images of ink-characters printing and braille embossing at times when actual ink-characters printing and braille embossing are performed (see D23 of FIG. 12 and D30 to D32 of FIG. 14).

A description will now be made specifically about examples of inputting character (braille) information in accordance with, in particular, braille input instructions (depression of the braille input key).

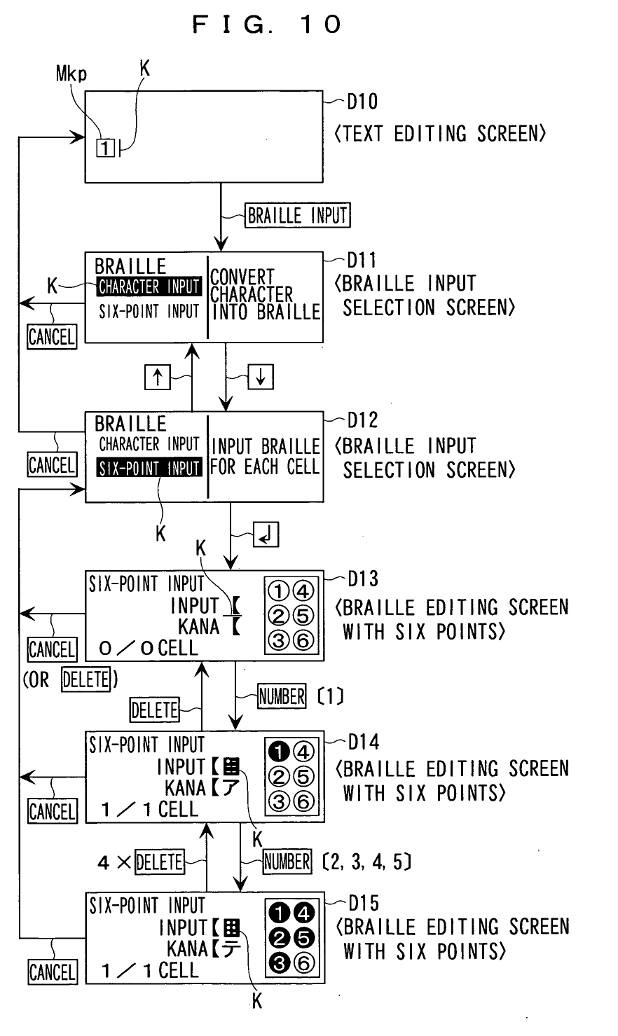

First, as shown, for example, in FIG. 10, in an initial state before the beginning of a text editing, a line number of the first line at which editing starts (Mkp as an ink-character mark) is displayed. Also displayed herein is a cursor K which prompts the user to input a first character of the first line (the text editing screen: screen D10: a display screen of the display 4 is hereinafter indicated as a screen Dxx and only the screen Dxx will be used for display and description).

In this state (D10), when the braille input key is depressed (the interruption of braille input instructions (INTB) of FIG. 7), the screen changes to a selection screen as a first phase (braille input selection screen) (D11). Note that the user is allowed to cancel various instructions and input data generated by a keystroke by depressing a deletion key (one character is deleted each time the key is depressed) or a cancel key so as to return to the initial state, the point-to-point operation of which will be omitted accordingly.

In the above state (D11), the user is allowed to select and specify, as an alternative, by cursor operation either “CHARACTER INPUT” according to which braille is inputted based on character input or “SIX-POINT INPUT” according to which an embossing point is specified so that braille (cell) is inputted on a point-by-point basis (immediately after the screen changes, the alternative previously used is specified and displayed by cursor operation as default: “CHARACTER INPUT” is to be set initially as default). Note that, on the following various screens as well, the alternative previously used is to be specified and displayed by cursor operation as default immediately after the screen changes as a rule. Accordingly, a description thereof will be omitted and only matters relating to an initial setting will be noted as required.

In the above state (D11), when the user now specifies by cursor operation “SIX-POINT INPUT” (D12), and selects the same by depressing an enter key (hereinafter simply referred to as “select and determine”), “SIX-POINT INPUT” is set as a braille input method (braille input mode). Then, the screen changes to an editing screen (braille editing screen with six points: second phase) in which an embossing point is specified so that braille is inputted and edited (D13).

On this editing screen, embossing points in each braille cell can be specified as point numbers consisting of 1 to 6, representing first to sixth points. When the number key “1,” for example, is depressed, an indication of the point number 1 shown on the right side of the screen is caused to change, thereby displaying (defining) that the first point is specified (inputted). Then, the cursor K is moved to the right space of “INPUT[” in an “INPUT” column, to display in reverse video a braille image (cell image) for only the first point because it is undetermined. Furthermore, “ [symbol] ,” a katakana character as converted from a hiragana character (i.e., hiragana version) “ [symbol] ” (braille transcription character) corresponding only to the first point is displayed in the “KANA” column (D14).

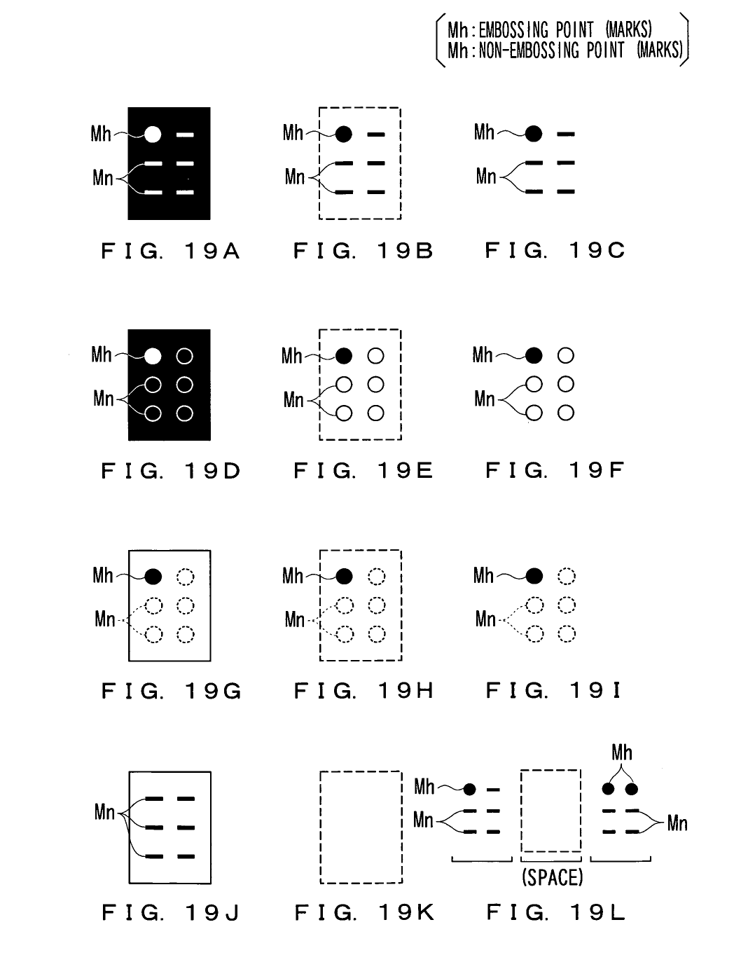

An indication of “●” in a cell image displayed in the “INPUT” column or “◯” displayed in reverse video thereof refers to an embossing point. In the above example, the image shows that the first point is an embossing point. On the other hand, an indication of “-” corresponding to other points or that displayed in reverse video thereof refers to a non-embossing point. In the above example, the image shows that the second to sixth points are non-embossing points (D14: see FIG. 19A)

In the above state (D14), when numbers “2, 3, 4, and 5” are additionally inputted in the same manner, points “1, 2, 3, 4, and 5” (first to fifth points) are specified as embossing points. As a result, only point 6 is specified as a non-embossing point, and a braille (cell) image thereof is displayed in the “INPUT” column in an undetermined state. At the same time, “ [symbol] , ” a katakana character as converted from a corresponding braille transcription character “ [symbol] ” is displayed in the “KANA” column (D15).

The specification of each embossing point (number specification) may be deleted on its way by depressing the deletion key or the like, and the deleted specification may be restored thereafter. Furthermore, a random inputting sequence of numbers (specification of embossing points) may be used. For example, in a state where points “2, 3, and 4” are inputted to generate a katakana character “ [symbol] ,” when point “5” is additionally inputted, the character changes to another katakana character “ [symbol] .” Subsequently, when point “1” is additionally inputted, the character changes to another katakana character “ [symbol] .”

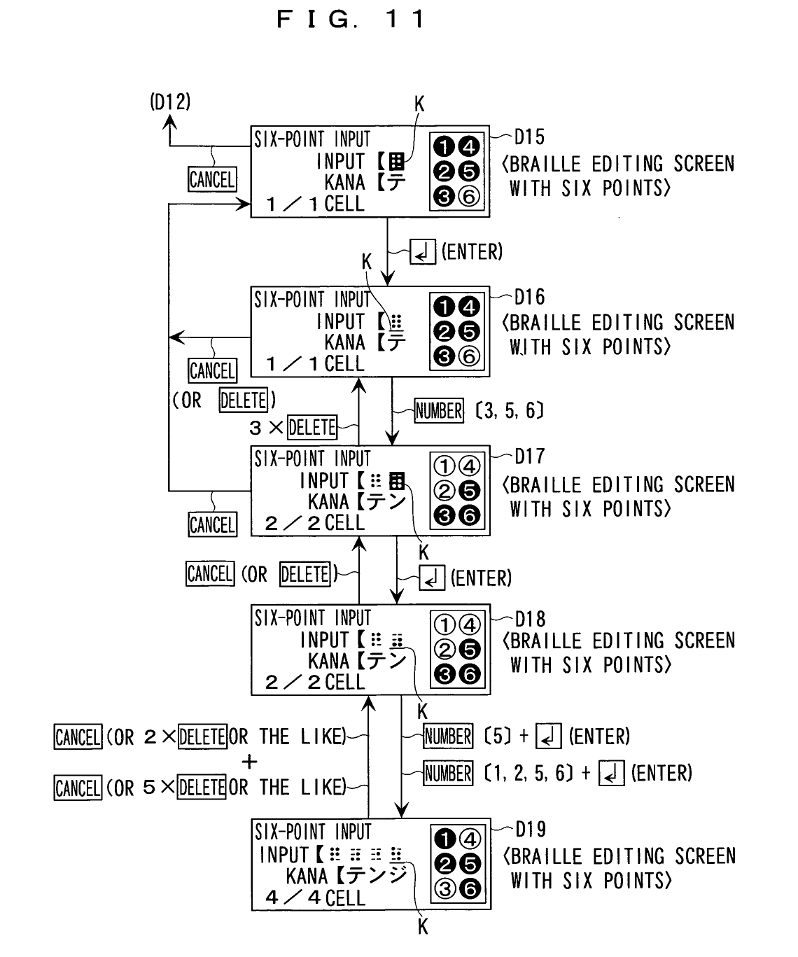

As shown in FIG. 11 (D15: common to FIG. 10), when the determination (enter key) is depressed after it is confirmed that the first cell representing the katakana character “ [symbol] ” is inputted as arranged in the above state, the cell is displayed in the INPUT column in a determined state as converted from an undetermined state, with the state of the cell being converted from a reverse video display to a normal display (D16).

Next, in this state (D16), when numbers “3, 5, and 6” are inputted (specification of embossing points) in the same manner, a cell image thereof is displayed in the “INPUT” column in an undetermined state, and a corresponding braille transcription character “ [symbol] ” is displayed in the “KANA” column at the same time (D17). When the enter key is depressed after it is confirmed that the cell representing the katakana character [symbol] is inputted, the cell is displayed in a determined state as converted from an undetermined (reverse video) state (D18).

Then, in this state (D18), when number “5” is inputted in the same manner, a cell image thereof is displayed in an undetermined state. The image is not displayed, but remains on standby in a corresponding KANA column, because the inputted number refers to a voiced sound symbol. When numbers “1, 2, 5, and 6” are inputted after determining the standby state of the voiced sound symbol (depression of the enter key), a katakana character “ [symbol] ,” which is a voiced sound character of a corresponding katakana character “ [symbol] ,” is displayed in the “KANA” column as a braille transcription character. When the enter key is depressed after it is confirmed that the cell representing the katakana character “ [symbol] ” is inputted, the cell is displayed in a determined state, and the katakana character “ [symbol] ” is also determined (D19).

As shown in FIG. 12 (D19: common to FIG. 11), when the enter key is depressed after it is confirmed that the cells representing katakana characters “ [symbol] ” are inputted as arranged in the above state, the braille (cells) representing the katakana characters “ [symbol] ” are determined, and the screen changes to the text editing screen (braille-character editing screen: one of the text editing screens) (D20).

Herein, the katakana characters “ [symbol] ” aligned with braille marks Mkb (all of which resemble the cell representing a katakana character “ [symbol] ”) are displayed so as to define that the cells corresponding to the characters “ [symbol] ” are inputted and determined. Furthermore, to make it easy for the side of ink characters to correspond to the same character information as the side of braille, both the ink-characters mark Mkp indicative of a line number of the first line and the characters “ [symbol] ” in an undetermined state are displayed as an input line for ink characters (D20).

With respect to ink characters, this state (D20) refers to the one (displayed in reverse video) in which a string of the katakana characters “ [symbol] ” is inputted and undetermined. Therefore, when it is desired that a string of another characters is inputted in ink, the undetermined state of the katakana characters “ [symbol] ” is deleted (canceled) by the deletion key to make a state in which no ink characters are inputted. Thereafter, a string of characters desired to be newly printed as ink characters may be inputted.

In this case, however, when the conversion key is depressed so that the characters are converted into kanji characters thereof while the undetermined state of the katakana characters “ [symbol] ” remains as it is, the undetermined state of the kanji characters “ [symbol] ,” for example, is caused to occur (D21). When the enter key is depressed after it is confirmed that the kanji characters “ [symbol] ” are in the undetermined state, the kanji characters “ [symbol] ” as ink characters are determined (D22). Note that, when the conversion key is further depressed while the kanji characters “ [symbol] ” are in the undetermined state, the kanji characters may be converted into hiragana characters (i.e., hiragana version) “ [symbol] ” or other kanji characters thereof (homophonous characters such as “ [symbol] ”), or the katakana characters (i.e., hiragana version) “ [symbol] ,” which are generated before the conversion key is depressed, may be determined as they are.

Next, in the above state (D22), when the printing key is depressed to cause a print interruption to occur (INTG of FIG. 7), labels as shown in FIGS. 13A to 13C are formed by the use of a tape having a width of 12 mm. In a case that the second process mode (ink characters only) is selected, ink-characters printing is performed based on an ink-characters image Gp0 to form a label Lp0. In a case that the third process mode (braille only) is selected, braille embossing is performed based on a braille image Gb0 to form a label Lb0. In a case that the first process mode (ink characters and braille in combination) is selected, ink-characters printing is performed based on the ink-characters image Gp0 and then the braille embossing is performed based on the braille image Gb0 to form a label L00 having an appearance (image) G00 on which ink characters and braille are arranged.

Therefore, in the above state (D22 of FIG. 12), when the preview key is depressed to cause a preview display interruption to occur (INTR of FIG. 7), a process for a preview display starts (S31). When the first process mode (ink characters and braille in combination), for example, is selected, the image of the label L00 on which the braille image and the ink-characters image are overlapped is (preview)-displayed (D23).

Meanwhile, on the braille editing screen with six points as described above, the user performs editing while handling an image of a six-point cell including embossing points and non-embossing points. Therefore, displayed herein is a mark of a cell image (cell mark) including a mark (embossing point mark) such as “●” indicative of an embossing point and a mark (non-embossing point mark) such as “-” indicative of a non-embossing point.

Conversely, on the preview display screen (preview screen) as described above, an image of only embossing points is displayed (D23) in accordance with the setting results of the layout setting (S30 of FIG. 7) so that an image of braille (cell) to be actually embossed is faithfully displayed. In other words, an image of non-embossing points not reflected in the appearance of an actual label is not displayed, because the non-embossing points are not embossed.

On the preview screen (D23) displaying the label L00 and the image thereof, a print arrangement area Ep of a print arrangement area length PL of FIG. 13A smaller than that of FIG. 13C is laid over a common arrangement area Ec of a common arrangement area length CL (=embossing arrangement area length BL) with the so-called “left justification.” Alternatively, as shown, for example, in FIGS. 14A to 14F, a layout can be arbitrarily selected by changing a setting in the layout setting (S30) such as “center justification (centering)” (FIG. 14A: appearance G10, label L10, and preview screen D30), “right justification” (FIG. 14B: G11, L11, and D31), and “equal justification (space)” (FIG. 14C: G12, L12, and D32).

With the above case as a first example, braille (character) information is inputted in the first example with “SIX-POINT INPUT” according to which an embossing point is specified. Besides, also provided is “CHARACTER INPUT” according to which a corresponding character is inputted (specification of a braille transcription character) and which is more convenient for visually normal people. A description thereof will be made hereinafter as a second example.

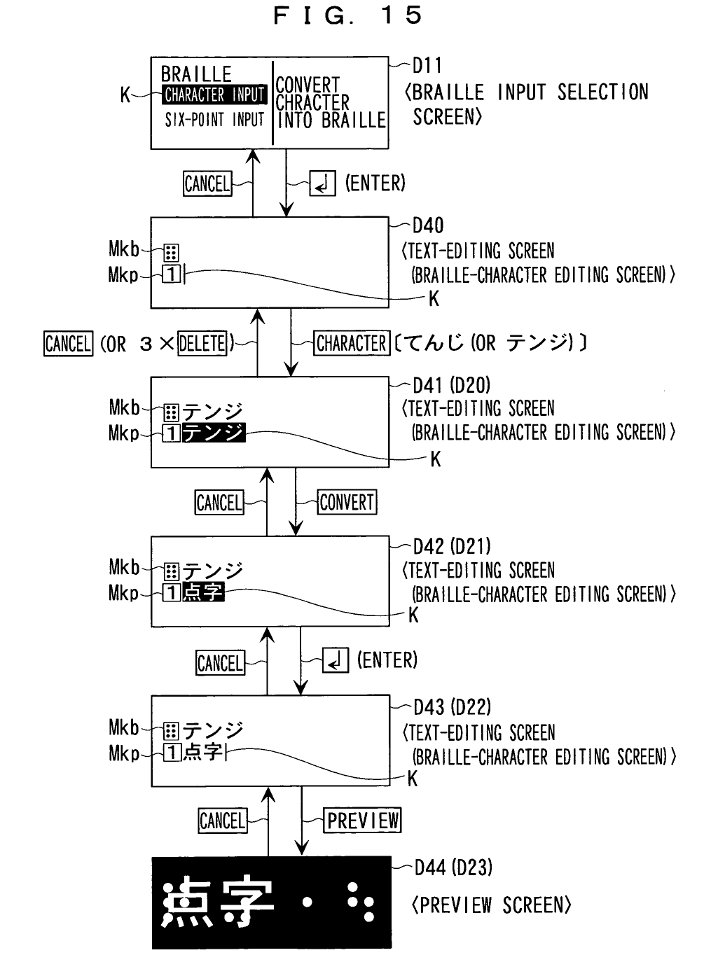

In this case, as shown, for example, in FIG. 15, when “CHARACTER INPUT” is selected and determined as it is on the braille input selection screen (D11: common to FIG. 10), said “CHARACTER INPUT” is set as the braille input method (braille input mode). Then, the screen changes to the braille-character editing screen in which the braille mark Mkb and the ink-characters mark Mkp are displayed while no inputting is made on either side of braille or ink characters, and the cursor K prompts the user to input a first character (D40).

Next, in this state (D40), when a string of hiragana characters “ [symbol] ” (or katakana characters “ [symbol] ”) is inputted, said inputted string of the hiragana characters “ [symbol] ” in an undetermined state (or the katakana characters “ [symbol] ” used in the figure in conformity with FIG. 12) is displayed on the side of ink characters indicated by the ink-characters mark Mkp, and the katakana characters “ [symbol] ,” a string of the characters (string of braille transcription characters) to be converted into braille (braille transcription), is displayed on the side of braille indicated by the braille mark Mkb (D41: same as D20 of FIG. 12).

Next, when the conversion key is depressed so that the characters are converted into kanji characters (i.e., kanji version) in a manner similar to the first example of FIG. 12, kanji characters “ [symbol] ,” for example, can be inputted and determined (D42 and D43: same as D21 and D22 of FIG. 12). In this case as well, the characters may be converted into hiragana characters (i.e., hiragana version) “ [symbol] ” or katakana characters (i.e., katakana version) [symbol] or other kanji characters (homophonous characters such as “ [symbol] ”) through the operation of the conversion key or the like.

In the above state (D43), when the printing key is depressed to cause a print interruption to occur as described above (INTG of FIG. 7), the label L00 or the like as described in FIG. 13C can be formed in accordance with the process mode. Therefore, in the above state (D43), when the preview key is depressed to cause a preview display interruption to occur (INTR of FIG. 7), the image of the label L00 or the like is preview-displayed (D44: same as D23 of FIG. 12).

A description will now be made about a third example referring to a display screen (braille-information editing screen) which allows the user to handle a string of inputted characters, a string of braille transcription characters, and corresponding braille images in a more distinctive manner than the second example, developing them as editable display screens at the same time.

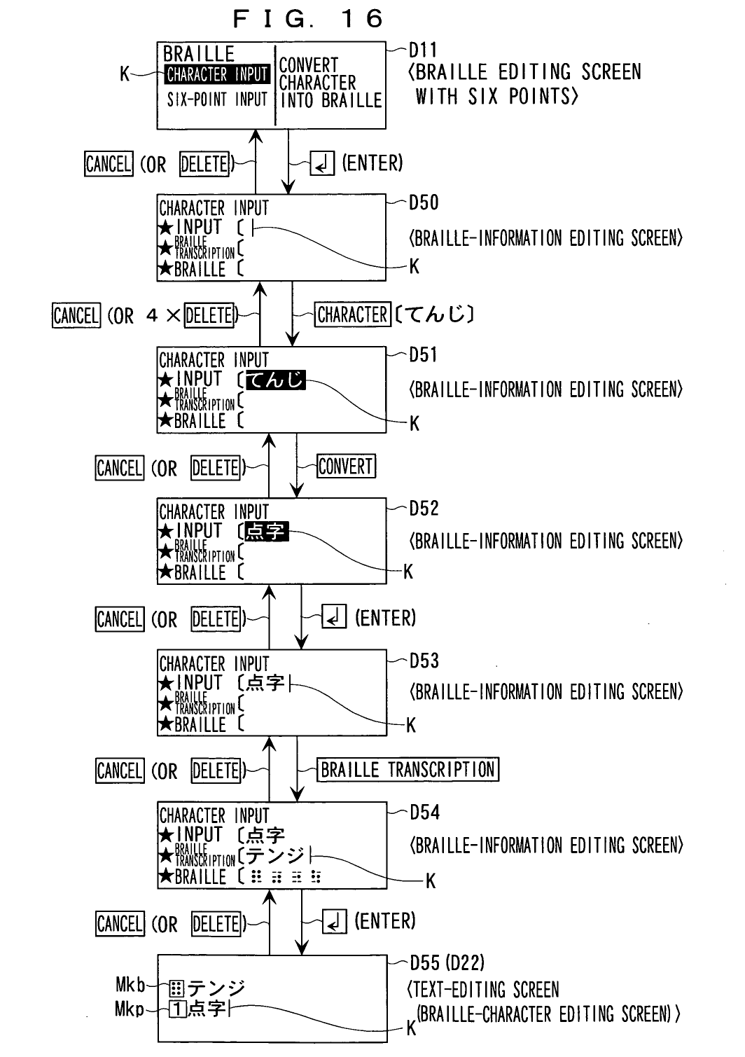

In this case, as shown, for example, in FIG. 16, when “CHARACTER INPUT” is selected and determined as it is on the braille input selection screen (D11: common to FIG. 10), said “CHARACTER INPUT” is set as the braille input method (braille input mode), and the screen changes to the braille-information editing screen (D50).

Displayed on the braille-information editing screen are: an “INPUT” column in which a string of normal characters is inputted and edited; a “BRAILLE TRANSCRIPTION” column in which a string of braille transcription characters is inputted and edited; and a “BRAILLE” column in which braille cell images corresponding to the string of the braille transcription characters is displayed, in such a way that they are arranged in parallel in each line. In an initial state, the cursor K prompts the user to input a first character in the “INPUT” column (D50).

Next, in this state (D50), when a string of normal characters “ [symbol] ” is inputted, said string is displayed in an undetermined state. Thereafter, when the conversion key is depressed in this state (D51), kanji characters “ [symbol] ,” for example, can be inputted and determined as described above (D52 and D53). In this case as well, the characters may be converted into hiragana characters (i.e., hiragana version) “ [symbol] ” or katakana characters (i.e., katakana version) [symbol] or other kanji characters through the operation of the conversion key or the like. Furthermore, in this case, the user is allowed to keep inputting another string of characters or perform various other editing in the above state (D53).

Now, when the braille transcription key is depressed in the above state (D53), the string of the kanji characters “ [symbol] ” is temporarily determined as a string of normal characters (string of ink characters). Then, a string of braille transcription characters “ [symbol] ,” which is transcribed from the string of ink characters “ [symbol] ,” is displayed in the “BRAILLE TRANSCRIPTION” column, and images of corresponding braille cells are displayed in the “BRAILLE” column. The cursor K is caused to move to the “BRAILLE TRANSCRIPTION” column to indicate that the string of the braille transcription characters can be edited (D54).

In this state (D54), the user is allowed to edit the string of the braille transcription characters in the “BRAILLE TRANSCRIPTION” column so that another string of characters is generated regardless of the string of ink characters in the “INPUT” column involved. In the “BRAILLE” column, braille cell images corresponding to the string of the edited braille transcription characters is represented by a cell mark.

In this state, the cursor K may be arranged in such a way as to move to the “BRAILLE” column, for example. After the cursor K is moved, a cell in the “BRAILLE” column may be directly edited by specifying embossing points in a manner similar to SIX-POINT INPUT as described in FIG. 11.

Herein, as shown in the figure, let it be assumed that no changes are made in the “BRAILLE TRANSCRIPTION” column and the “BRAILLE” column. When the enter key is depressed after it is confirmed that no changes are made in the “BRAILLE TRANSCRIPTION” column and the “BRAILLE” column, the string of ink characters “ [symbol] ” in the “INPUT” column, the string of the braille transcription characters [symbol] in the “BRAILLE TRANSCRIPTION” column, and the cell marks of the corresponding cell images in the “BRAILLE” column are determined, and the screen changes to the braille-character editing screen as described in FIG. 12 (D55: same as D22 of FIG. 12).

Therefore, in the above state (D55), when the printing key is depressed to cause a print interruption to occur (INTG of FIG. 7), the label L00 or the like as described in FIG. 13 can be formed in accordance with the process mode. When the preview key is depressed to cause a preview display interruption to occur (INTR of FIG. 7), the image of the label L00 or the like is preview-displayed (see D22 of FIG. 12, D44 of FIG. 15, or the like).

Unlike the above-described examples (the first to the third examples) in which the screen changes to the dedicated edit screen for inputting and editing braille, a description will now be made about a fourth example which allows the user to directly perform braille transcription on a normal text-editing screen for editing ink characters.

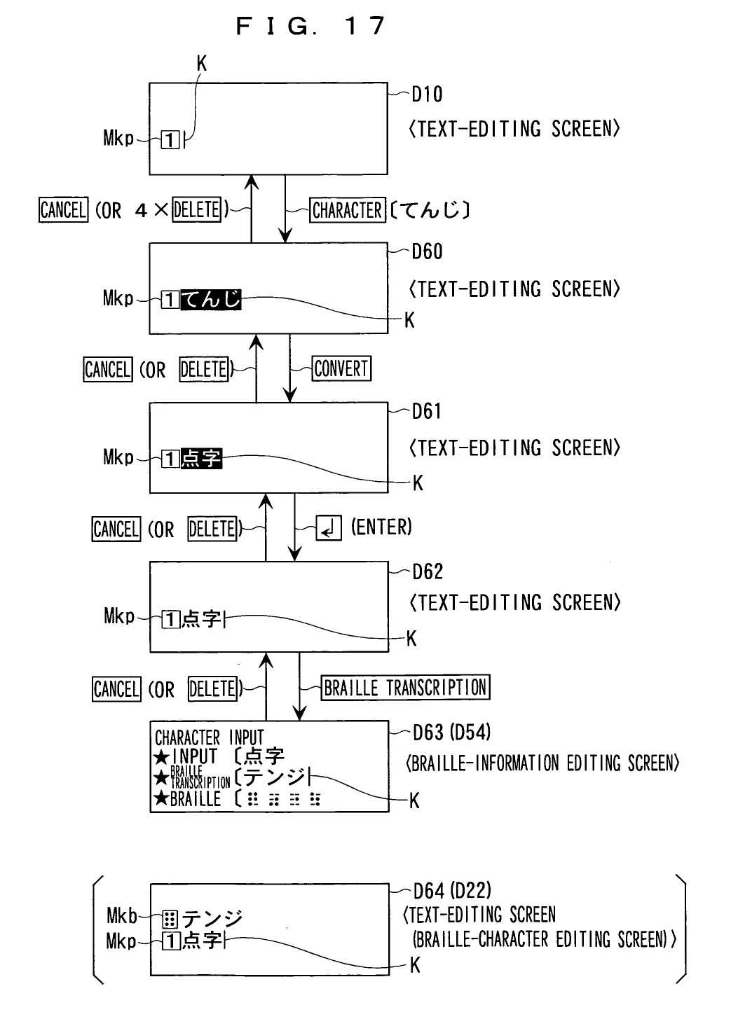

In this case, as shown, for example, in FIG. 17, when a string of normal characters (string of ink-characters) “ [symbol] ” is inputted on the text editing screen (D10: common to FIG. 10), said string is displayed in an undetermined state. Thereafter, when the conversion key is depressed in this state (D60), kanji characters “ [symbol] ,” for example, can be inputted and determined as described above (D61 and D62). In this case as well, the characters may be converted into hiragana characters (i.e., hiragana version) “ [symbol] ” or katakana character (i.e., katakana version) [symbol] or other kanji characters through the operation of the conversion key or the like. Furthermore, in this case, the user is allowed to keep inputting another string of characters or perform various other editing in the above state (D62).

Now, when the braille transcription key is depressed in the above state (D62), the string of the ink characters “ [symbol] ” is determined, and then the screen changes to the braille-information editing screen as described above (D63: same as D54 of FIG. 15). In this state (D63), the user is allowed to edit a string of braille transcription characters in the “BRAILLE TRANSCRIPTION” column regardless of the string of ink characters in the “INPUT” column. In the “BRAILLE” column, braille cell images corresponding to the string of the edited braille transcription characters are represented by a cell mark. Note that the screen may directly change to the braille-character editing screen (D64: same as D22 of FIG. 12) rather than to said screen (D63).

As described above, according to the label forming apparatus 1 of the present embodiment, a cell mark indicative of a braille cell image is displayed as an edit display. The cell mark is constituted of an embossing point mark such as “●” or “◯,” which indicates an embossing point, and of an non-embossing point mark such as “-” or that displayed in reverse video thereof, which indicates a non-embossing point.

In other words, in the “INPUT” column of “SIX-POINT INPUT” for braille inputting (see FIGS. 10 and 11 of the first example) and the “BRAILLE” column of “CHARACTER INPUT” (see FIG. 16 of FIG. 3), a cell mark including a non-embossing point mark and an embossing point mark is displayed, so that an embossing point and a non-embossing point are definitely represented. Furthermore, the user is allowed to easily and exactly handle editing results of a braille cell image to be edited.

On the other hand, the preview display displays an image of only an embossing point to be reflected in an actual embossing result, thereby allowing the user to easily and exactly handle an embossing image prior to an embossing process (see D23 of FIG. 12, D30 to D32 of FIG. 14, or D44 of FIG. 15). Furthermore, in the case of the first process mode (ink characters and braille in combination), a print image of ink-characters printing is preview-displayed together with an embossing image in accordance with a layout set by the layout setting (S30). Therefore, the user is allowed to easily and exactly handle an image of (the process results for a sheet processing consisting of) braille embossing and ink-characters printing relative to the tape (common process sheet) T prior to printing and embossing processes. As a result, usability can be further enhanced.

Furthermore, as described in the first example of FIGS. 10 to 12, the user is allowed to easily edit braille information of a cell image represented by a cell mark by specifying embossing points on a point-by-point basis.

Note that the first example refers only to editing in which one embossing point is specified and another embossing point is subsequently added. Note further that it is also possible to respecify the specified point as a non-embossing point.

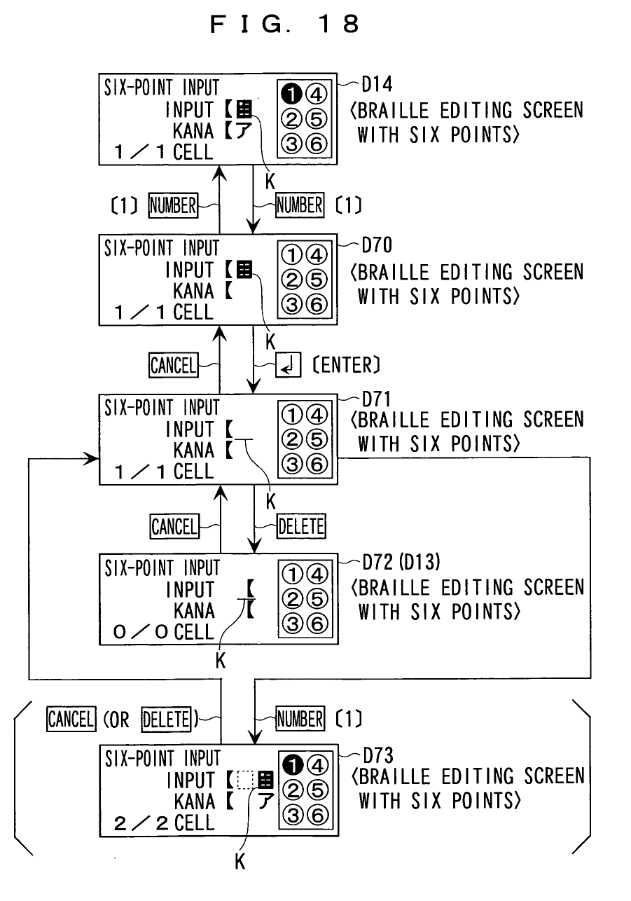

As shown, for example, in FIG. 18, in a state where the first point is specified as an embossing point (i.e., representing a state of a braille cell corresponding to a katakana character “ [symbol] ”), an embossing point mark (“◯” representing an undetermined state of “●”) is displayed as the first point, and other points (second to sixth points) are represented by non-embossing point marks (“-” in reverse video) because they are non-embossing points (D14: common to FIG. 14).

In this state (D14), when number “1” is inputted by the number key “1,” the first point as represented by the embossing point mark is changed to a non-embossing point mark representing a non-embossing point and is displayed (D70). In other words, the inputting of the number “1” in this case means a process of specifying in which an embossing point is changed to a non-embossing point.

Furthermore, in this case, since the first point, which was the only embossing point, changes to the non-embossing point, the cell having no embossing points, i.e., a blank state, should occur. In an undetermined state, however, a cell mark including only non-embossing point marks is displayed to make it easy for the user to input a cell specifying embossing points again. Thus, when any of the numbers “1” to “6” is inputted herein, a corresponding point is changed to an embossing point mark.

On the other hand, in a state where the cell mark including only non-embossing point marks is displayed (D70), the blank cell is determined (D71) when the enter key is depressed after said state is confirmed.

In the state (D71), when the deletion key is depressed, the determined blank cell is deleted, and the “INPUT” column is returned to the initial state (D72: same as D13 of FIG. 10).

Furthermore, in the above state (D71), when another number, number “1,” for example, is inputted by number key “1,” the first point as an embossing point is specified for the next cell while the blank cell remains determined. That is, the cell next to the blank cell is represented by a cell mark, with only the first point being an embossing point mark and the other points being non-embossing point marks (D73).

According to the present embodiment, as shown, for example, in FIG. 19A, an embossing point mark Mh is represented by “●” while non-embossing point marks Mn is represented by “-” in the above manner. Furthermore, an undetermined state of such embossing point and non-embossing point marks is shown in reverse video while a determined state thereof in normal video (FIGS. 19A and 19C show an undetermined state and a determined state, respectively). Alternatively, an undetermined state may be represented by another display method such as that using a dotted frame as shown in FIG. 19B.

Likewise, the non-embossing point mark Mn “-” may be replaced by “◯” formed by a solid line (see FIG. 19D to 19F) or by “◯” formed by a dotted line (see FIG. 19G to 19I). The undetermined state may be replaced by a solid-line frame (see FIG. 19G) rather than by reverse display.

In the present embodiment, a blank cell is represented by a cell mark including only non-embossing point marks “-,” i.e., reversed type of “-”, only in an undetermined state. In a determined state as well, however, a cell mark including only “-” may be used in place of a blank (see FIG. 19J). Furthermore, a cell mark formed only by a dotted frame may be used to facilitate the user to picture a blank cell (see FIGS. 19K and 19L).

Displayed in the present embodiment is not only a cell mark indicative of a cell image (braille information represented by the cell mark), but also braille transcription information as information represented by a character corresponding to the cell mark (string of braille transcription characters in the “KANA” column of SIX-POINT INPUT as shown in the first example (see FIGS. 10 and 11), a string of braille transcription characters on the braille-character editing screen as shown in the first and the second examples (the line on the upper side of D20 to D22 of FIG. 12, and the line on the upper side of D41 to D43 of FIG. 15), and a string of braille transcription characters in the “BRAILLE TRANSCRIPTION” column as shown in the third and the fourth examples (see FIGS. 16 and 17). Therefore, the user is allowed to easily handle a braille cell image as well as the meaning thereof. As a result, usability can be further enhanced.

The user is allowed to directly edit the string of the braille transcription characters (see D54 of FIG. 16 as shown in the third example and D63 of FIG. 17 as shown in the fourth example). By editing braille-transcription information, the user is allowed to easily edit braille information of a cell image. As a result, usability can be further enhanced.

Furthermore, displayed in the present embodiment are a string of ink characters (ink-characters information) (a string of ink characters on the braille-character editing screen as shown in the first and the second examples (the line on the lower side of D20 to D22 of FIG. 12 and the line on the lower side of D40 to D43 of FIG. 15) and a string of ink characters in the “INPUT” column as shown in the third and the fourth examples (see FIGS. 16 and 17)), as well as a cell mark and a string of braille transcription characters. Therefore, the user is allowed to handle a braille cell image and the meaning (content) thereof as well as contents on the side of ink characters because ink-characters information is displayed. Furthermore, even when ink characters (printing) and braille (embossing) represent different character information, respectively, the user is easily notified of the fact.

It is also possible to edit a string of ink characters (ink-characters information) and reflect the same in braille-transcription information (see FIGS. 15 to 17 as shown in the second, third, and fourth examples) Therefore, the user is allowed to indirectly edit braille information of a cell image by editing the ink-characters information. As a result, usability can be further enhanced. Furthermore, ink-characters information can be displayed in such a way that it is arranged in parallel with a cell mark and a string of braille transcription characters at the same time (see FIG. 16 as shown in the third example). Therefore, the user is allowed to handle braille information of a cell image represented by a cell mark, the meaning thereof (braille-transcription information), and contents on the side of ink characters (ink-characters information) at the same time, and to easily see the relation between ink characters (printing) and braille (embossing).

The functions or various process methods (braille-information processing method) as the braille-information processing apparatus employed in the above embodiment can be applied not only to the label forming apparatus 1, but also to a program which is processed by various devices capable of processing the program and to a storage medium which stores such a program. By reading out such a program from the storage medium or the like and executing the same, the user is allowed to easily and exactly handle editing results of a braille cell image and an embossing image prior to an embossing process. As a result, usability can be further enhanced.

The storage medium includes a CD-ROM, a flash ROM, a memory card (such as compact flash (TM), smart media, an memory stick), a compact disk, a magneto-optical disk, a digital versatile disk, a flexible disk, etc., and various changes and modifications may be made without departing from the spirit and scope thereof.

What is claimed is:

1. A braille-information processing apparatus capable of performing, on a display screen, an edit display for editing braille information for braille embossing and a preview display for displaying an embossing image for the braille embossing, the apparatus comprising:
edit display means for displaying, as the edit display, a cell mark including a non-embossing point mark indicative of a non-embossing point in each braille cell and an embossing point mark indicative of an embossing point in each braille cell, the embossing point mark being different in shape from the non-embossing point mark; and
preview display means for displaying, as the preview display, a cell image of only the embossing point out of the non-embossing point and the embossing point.

2. The braille-information processing apparatus according to claim 1, further comprising
point-specifying edit means capable of editing the cell mark by specifying either the embossing point or the non-embossing point.

3. The braille-information processing apparatus according to claim 1, wherein the edit display means includes:
cell mark display means for displaying the cell mark; and
braille-transcription information display means for displaying braille-transcription information as information represented by a character corresponding to the cell mark.

4. The braille-information processing apparatus according to claim 3, wherein the edit display means further includes
ink-characters information display means for displaying ink-characters information for ink-characters printing to be printed on a process sheet used in common with the braille embossing.

5. A braille-information processing method capable of performing an edit display for editing braille information for braille embossing and a preview display for displaying an embossing image for the braille embossing, the method comprising:
displaying, as the edit display, a cell mark including a non-embossing point mark indicative of a non-embossing point in each braille cell and an embossing point mark indicative of an embossing point in each braille cell; and
displaying, as the preview display, a cell image of only the embossing point out of the non-embossing point and the embossing point.

6. A program which performs the braille-information processing apparatus as defined in any one of claims 1 to 4.

7. A storage medium which stores the program as defined in claim 6 in such a way that it is readable by a device capable of processing the program.
